(19) United States
(12) Patent Application Publication
(10) Pub. No.: US 2012/0121231 A1
(43) Pub. Date: May 17, 2012

(54) DIGITAL BROADCAST RECEIVER HAVING A RECORDING FUNCTION

(76) Inventors: Hiroaki Saitoh, Osaka (JP); Yukimi Kawaguchi, Osaka (JP); Nobuyuki Murashima, Osaka (JP); Tadamichi Atsumi, Osaka (JP); Toru Hirota, Osaka (JP)

(21) Appl. No.: 13/387,253

(22) PCT Filed: Jun. 24, 2010
(86) PCT No.: PCT/JP2010/060774

§ 371 Date: Jan. 26, 2012

(30) Foreign Application Priority Data
Jul. 27, 2009 (JP) 2009-174466

(51) Int. Cl. H04N 5/775

(52) U.S. Cl. 386/230; 386/E05.07

(57) ABSTRACT

Provided is a digital broadcast receiver having a recording function, which is capable of automatically selecting a recording destination of reserved recording. The digital broadcast receiver having a recording function includes a connection means 5 for connecting to another apparatus having a recording function, an interface means 11 for receiving, in reserved recording, a setting of performing reserved recording preferentially by the recording function of the receiver, and a control means 21 for performing such a control that, in a case where the setting of performing reserved recording preferentially by the recording function of the receiver has been made in the interface means, the control means determines, in reserved recording, whether or not the recording function of the receiver is available for the recording, when the recording function of the receiver is available for the recording, the control means performs the recording by the recording function of the receiver, and when the recording function of the receiver is not available for the recording, the control means causes the other apparatus connected to the connection means to perform the reserved recording.

### TECHNICAL FIELD

The present invention relates to a digital broadcast receiver having a recording function.

### BACKGROUND ART

A long time has passed since a recording device for a digital broadcast program has come up in the market to meet demands for recording a digital broadcast program. Now, a digital broadcast receiver having a recording function incorporated in the main body has emerged along with the advancement in the performance of the digital broadcast receiver. Accordingly, there are also a measurable number of users who attempt solution to a variety of recording demands by utilizing a recording device and a digital broadcast receiver having a recording function in combination.

Usually, when operation of a program recording reservation is to be conducted, the input source of the television is switched to an external recording device. However, if a television itself has a recording function, such function will be selected preferentially because of its better usability.

Patent Documents 1 discloses a recording control apparatus and a recording control method including: an acquiring means for acquiring device information of an externally connected recording device; a setting means for setting recording information for causing the recording device to record a program using a digital broadcast receiving function of a digital broadcast receiver; and a control means for, when setting of recording information to the recording device by designating date and time is requested, setting the recording information to the recording device based on the device information without determining whether or not the recording device is available for the recording according to the recording information requested to be set. This makes it possible to facilitate management of the recording information for the externally connected recording device to perform reserved recording, thereby achieving a highly versatile recording reservation, and also to improve the user's convenience.

### PRIOR ART DOCUMENT

### Patent Document

Patent Document 1: Japanese Patent Application Publication No. 2008-67327

### SUMMARY OF THE INVENTION

### Problems to be Solved by the Invention

However, when a storage capacity for recording is not sufficient for recording in a recording function of the television, it takes a lot of trouble to newly register a recording reservation with an external recording device. Also, there exists a demand to record the same program into a recording function of the television and also into an external recording device at the same time for backup or other like purposes.

In that case, it is troublesome to execute a procedure for registering the recording reservation with both the television and the external recording device respectively. Therefore, execution of the procedure at a time makes it possible to save time and also to avoid losing a chance of the recording due to an operational error.

In view of such circumstances, the present invention provides a digital broadcast receiver having a recording function which is capable of automatically selecting a recording destination for reserved recording.

### Means for Solving the Problems

A digital broadcast receiver of the present invention is a digital broadcast receiver having a recording function, characterized in that the digital broadcast receiver includes: a connection means for connecting to another apparatus having a recording function, an interface means for receiving, in reserved recording, a setting of performing reserved recording preferentially by the recording function of the receiver, and a control means for performing such a control that, in a case where the setting of performing reserved recording preferentially by the recording function of the receiver has been made in the interface means, the control means determines, in reserved recording, whether or not the recording function of the receiver is available for the recording, when the recording function of the receiver is available for the recording, the control means performs the recording by the recording function of the receiver, and when the recording function of the receiver is not available for the recording, the control means causes the other apparatus connected to the connection means to perform the reserved recording.

When determining that the recording function of the receiver is not available for the recording due to shortage of storage capacity, in the reserved recording, the control means may perform such a control as to cause the other apparatus connected to the connection means to perform the reserved recording, and perform the reserved recording by the recording function of the receiver.

The interface means may further receive a setting of always performing reserved recording by both of the recording function of the receiver and a recording function of the other apparatus, and when the setting of always performing reserved recording by both of the recording function of the receiver and the recording function of the other apparatus has been made in the interface means, the control means may perform, in the reserved recording, such a control as to simultaneously perform the recording by the recording function of the receiver, and cause the other apparatus connected to the connection means to perform the recording.

When determining that the recording function of the receiver is not available for the recording, and when the control means performs such a control as to cause the other apparatus connected to the connection means to perform the recording, the control means may output a message notifying to that effect.

When determining that the recording function of the receiver is not available for the recording, and when the control means performs such a control as to cause the other apparatus connected to the connection means to perform the recording and the recording by the other apparatus has failed, the control means may output a message notifying to that effect.

### Effects of the Invention

According to an aspect of the present invention, a recording destination of reserved recording can be selected automatically.

### BRIEF DESCRIPTION OF THE DRAWINGS

FIG. 1 is a block diagram showing an example of the configuration of a digital broadcast receiver having a recording function according to the present invention.

FIG. 2 is a block diagram showing an example of the configuration of a hybrid recorder connected to a digital liquid crystal television apparatus.

FIG. 3 is a diagram showing the digital liquid crystal television apparatus and the hybrid recorder connected to each other via a HDMI cable.

FIG. 4 is a diagram showing an example of a reservation setting screen of the digital liquid crystal television apparatus.

FIG. 5 is a flowchart for explaining an operational flow when performing reserved recording in the digital broadcast receiver having the recording function according to the present invention.

FIG. 6 is a diagram for explaining various configurations to which the present invention is applicable.

### EXPLANATION OF REFERENCE NUMERALS

1 Antenna
3 Digital Broadcast Receiver
5 HDMI Interface Unit
7 HDMI Signal Processing Unit
9 Decoder Unit
11 Remote-controller Light Receiving Unit
13 Voice Signal Processing Unit
15 Speaker
17 Image Signal Processing Unit
19 Display
21 Control Unit
23 Storage Unit
25 Electronic Program Table Acquisition Unit
27 BD Recorder unit
41 Antenna
43 Digital Tuner
45 HDMI Signal Processing Unit
47 Control Unit
49 Remote-controller Light Receiving Unit
51 Storage Unit (HDD)
53 HDMI Interface Unit
55 Electronic Program Table Acquisition Unit
57 Optical Disc Drive Unit
59 Operation Unit

### MODES FOR CARRYING OUT THE INVENTION

Hereinafter, embodiments of a digital broadcast receiver having a recording function according to the present invention are described in detail with reference to the accompanying drawings. As an example, the digital broadcast receiver having a recording function according to the present invention is assumed to be a digital liquid crystal television apparatus having a BD drive capable of recording, and another apparatus having a recording function as a hybrid recorder having a hard-disk drive or a DVD drive connected via the digital liquid crystal television apparatus and HDMI.

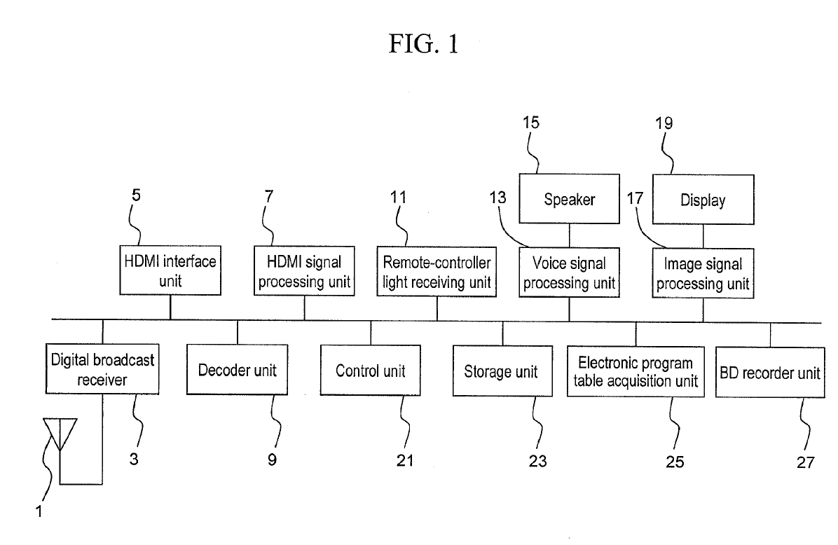

FIG. 1 is a block diagram showing an example of the configuration of a digital broadcast receiver having a recording function according to the present invention. The digital broadcast receiver having a recording function, which is a digital liquid crystal television apparatus, includes an antenna 1, a digital broadcast receiver 3 including a digital broadcast tuner, an HDMI interface unit 5, an HDMI signal processing unit 7, a decoder unit 9, a remote-controller light receiving unit 11, a voice signal processing unit 13 which processes voice signal, a speaker 15 which outputs voice based on processed voice signals, an image signal processing unit 17 which processes image signals, a display 19 which outputs an image based on processed image signals, a control unit (CPU) 21 which controls these functional blocks via a bus line, a storage unit 23 which stores programs and other information for performing processes described below, an electronic program table acquisition unit 25, and a BD recorder unit 27 which records and plays a broadcast program and external input signals.

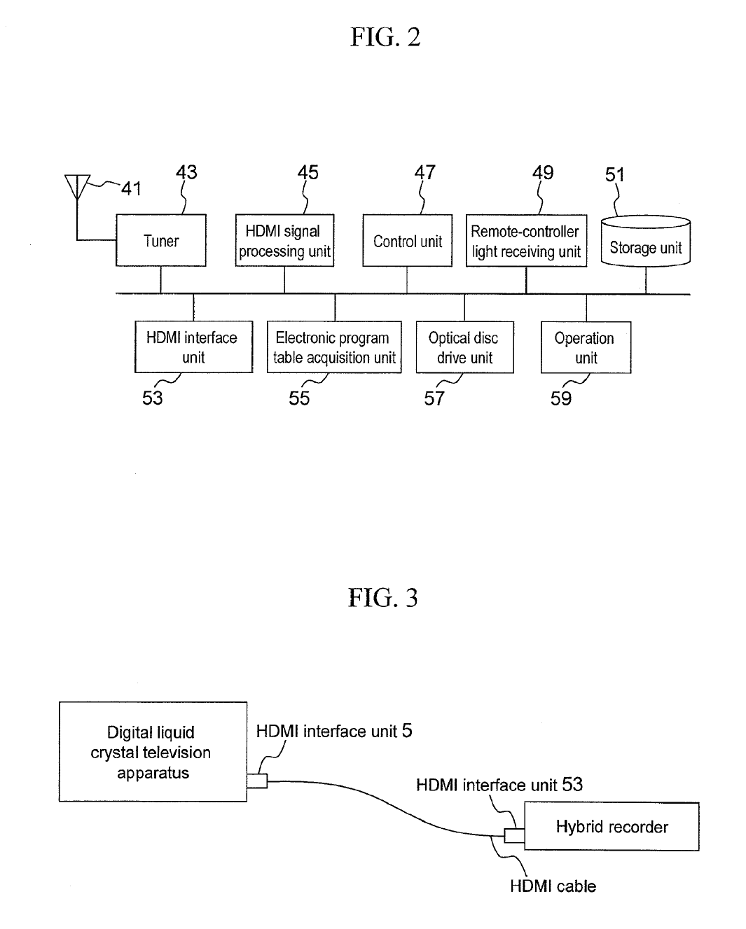

FIG. 2 is a block diagram showing an example of the configuration of a hybrid recorder connected to the digital liquid crystal television apparatus shown in FIG. 1. The hybrid recorder includes an antenna 41, a digital tuner 43, an HDMI signal processing unit 45, a control unit 47, a remote-controller light receiving unit 49, a storage unit (HDD) 51, an HDMI interface unit 53, an electronic program table acquisition unit 55, an optical disk drive 57 such as DVD, and an operation unit 59.

FIG. 3 is a diagram showing how the HDMI interface unit 5 of the digital liquid crystal television apparatus shown in FIG. 1 and the HDMI interface 53 of the hybrid recorder shown in FIG. 2 are connected to each other via an HDMI cable. Image signals, voice signals and control signals flow bi-directionally between the digital liquid crystal television apparatus and the hybrid recorder. Control processing between the two apparatuses can be performed based on control signals exchanged via the HDMI cable connecting the apparatuses to each other. Particularly, the digital liquid crystal television apparatus can control the hybrid recorder so as to cause the hybrid recorder to record a broadcast program.

According to an aspect of the present invention, the digital broadcast receiver having a recording function is capable of performing reserved recording, by using, for example, an EPG. Hereinafter, details thereof are described.

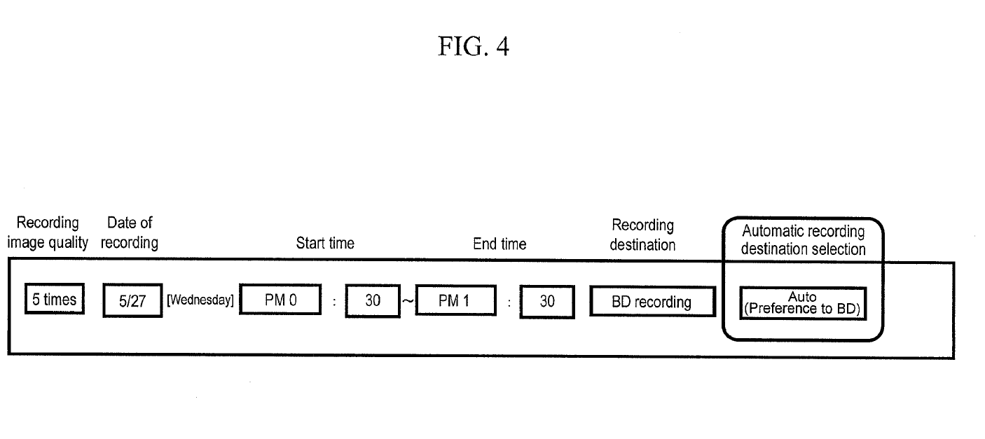

FIG. 4 is a diagram showing an example of the reservation setting screen on a digital liquid crystal television apparatus. Individual recording reservations made via EPG or the like can be further set in detail as shown in FIG. 4. The detailed setting includes, for example, a setting of the recording image quality, a setting of the recording date, a setting of the recording start time, a setting of the recording end time, a setting of recording destination (for example, the recording function of the receiver and another external apparatus having a recording function connected to the digital broadcast receiver), and the like.

A unique feature according to the present invention includes, for example, an automatic recording destination selection in the detail setting. In the automatic recording destination selection, any one of “NO”, “AUTO”, and “ALWAYS BOTH” can be selected.

When “NO” is selected, reserved recording is executed to a selected recording destination without performing the automatic recording destination selection.

When no other apparatus having a recording function is connected and the digital broadcast receiver has only one recording function, it is preferable not to provide an option other than “NO”.

When “ALWAYS BOTH” is selected, reserved recording is always performed by both a selected recording destination and another recording device (for example, a recording function of the receiver and another apparatus having a recording function).

When “AUTO” is selected, if any problem is detected from a selected recording destination, the recording destination is automatically changed to another recording device (for example, from a recording function of the receiver to another apparatus having a recording function).

When “AUTO” is selected, the control unit 21 determines, before starting the reserved recording (for example, 10 seconds before), whether or not a recording function selected as a recording destination (for example, a BD recorder unit 27 shown in FIG. 1) is available for recording. For example, when the recording function is a BD drive, conditions for determining that the recording function is not available for recording include “no disk”, “disk is being read”, “read-only disk”, “recording-disabled disk”, “protected disk”, “finalized”, “disk error”, “title max”, “chapter max”, “disk full”, “being initialized”, “not available for recording”, “internal error”, “no TS input”, or the like.

When a recording function selected as a recording destination is determined to be available for recording, reserved recording starts at a selected recording start time by the recording function selected as the recording destination. In this case, if recording failed due to a trouble with the recording function selected as a recording destination, the recording may be performed by another recording function.

When a recording function selected as a recording destination is determined not available for recording, the recording destination is changed to another recording function (for example, a HDD incorporated in the receiver or a BD drive or HDD of another apparatus). At a selected recording start time, reserved recording starts by a recording function at the changed recording destination. If a recording function of the original recording destination has been determined be available for recording but have not storage capacity sufficient to fully record a reserved program, the reserved recording also may be performed by a recording function at the original recording destination as far as possible.

When the recording destination is changed in “AUTO”, a message notifying the change to the user may be output. For example, a message “Recording destination has been changed to an externally connected device” may be output.

Further, when the recording destination has been changed in “AUTO” and recording by the changed recording destination failed, a message notifying the failure to the user may be output. For example, a message “Recording destination has been changed to an externally connected device, but recording failed” may be output. In this case, the message may include reason of the recording failure at the changed recording destination. For example, the following messages may be output: “Automatic recording destination selection failed since a designated externally connected device is not available”, “Automatic recording destination selection failed since the program could not be recorded into an externally connected device”, “Automatic recording destination selection failed since an externally connected device is not available for recording”, “Automatic recording destination selection failed since an externally connected device is playing”, “Automatic recording destination selection failed since an externally connected device is executing another recording”, “Automatic recording destination selection failed since an externally connected device could not receive the program”, “Automatic recording destination selection failed since an externally connected device is not available for recording”, or the like.

These messages may be saved as a report in the receiver and display later.

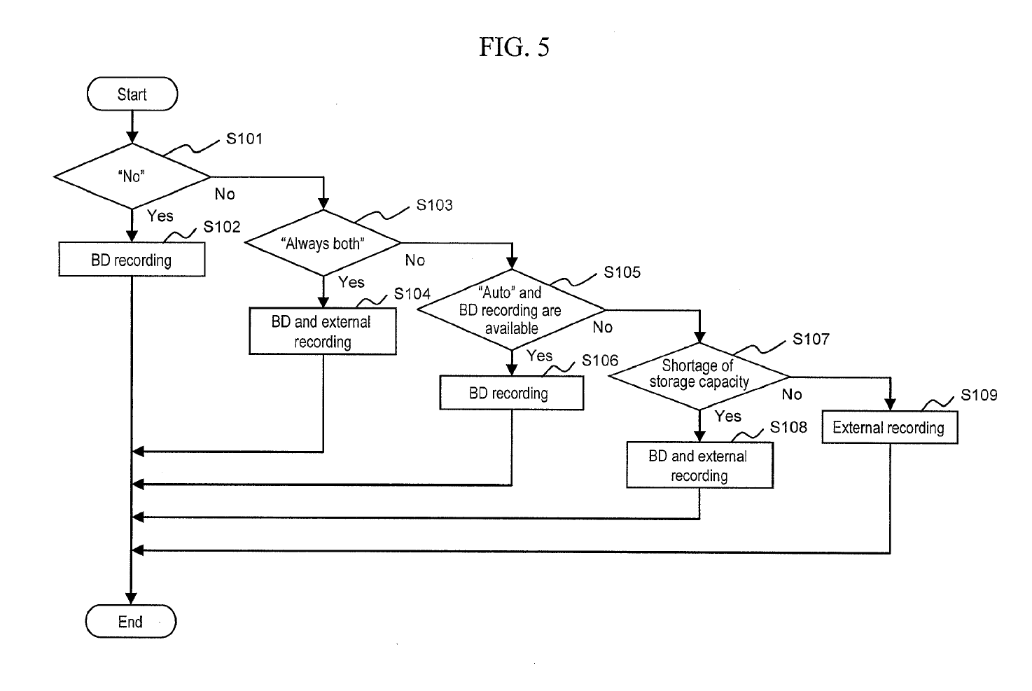

FIG. 5 is a flowchart for explaining an operational flow when performing reserved recording in a digital broadcast receiver having a recording function according to the present invention. In an example shown in FIG. 5, an initial recording destination is the BD recorder unit 27 (see FIG. 1) incorporated into the digital broadcast receiver having a recording function, and a selectable recording destination is an externally connected device such as the hybrid recorder shown in FIG. 2 connected via HDMI.

In Step S101, the control unit 21 determines, before reserved recording starts, for example, 10 minutes before starting, whether or not the automatic recording destination selection is set to “NO”. If “NO” is selected, the step proceeds to Step S102. Otherwise, the step proceeds to Step 103.

In Step S102, the control unit 21 performs the reserved recording by the BD recorder unit 27, and ends the operation.

In Step S103, the control unit 21 determines whether or not the automatic recording destination selection is set to “ALWAYS BOTH”. If set to “ALWAYS BOTH”, the step proceeds to Step S104. Otherwise, that is, if set to “AUTO”, the step proceeds to Step S105.

In Step S104, the control unit 21 performs the reserved recording by the BD recorder unit 27 while causing an externally connected device via HDMI to execute the same reserved recording, and ends the operation.

In Step S105, since the automatic recording destination selection is set to “AUTO”, the control unit 21 determines whether or not the BD recorder unit 27 is available for recording. If available for recording, the step proceeds to Step S106. Otherwise, the step proceeds to Step S107.

In Step S106, the control unit 21 performs the reserved recording by the BD recorder unit 27 and then ends the operation.

In Step S107, the control unit 21 determines whether or not the reason why the BD recorder unit 27 was not available for recording is due to shortage of the storage capacity for the reserved recording. If that is the case, the step proceeds to Step S108. Otherwise, the step proceeds to S109.

In Step S108, the control unit 21 performs the reserved recording by the BD recorder unit 27 while causing an externally connected device via HDMI to perform the same reserved recording, and ends the operation. In this case, recording by the BD recorder unit 27 might be stopped. In Step S108, the control unit 21 outputs a message notifying a change of the recording destination as described above, and if recording by the externally connected device failed, the control unit 21 outputs an additional message notifying the user to that effect.

In Step S109, the control unit 21 causes the externally connected device via HDMI to perform the reserved recording, and ends the operation. In Step S109, the control unit 21 outputs a message notifying that the recording destination has been changed as described above. If recording by the externally connected device failed, the control unit 21 outputs a message notifying to that effect.

As described above, even when the recording function of the receiver is not available for reserved recording, the digital broadcast receiver having a recording function according to the present invention can be set such that the reserved recording is automatically performed by an externally connected device or always by both a recorder of the digital broadcast receiver and an externally connected device, whereby loss of a recording chance can be minimized.

In the embodiments described above, the digital broadcast receiver having a recording function according to the present invention is described by citing a digital liquid crystal television apparatus having a BD recorder as an example thereof, and the selectable recording destination is described by citing a hybrid recorder unit connected via HDMI as an example thereof. But, the present invention is not limited to such configurations. The present invention is applicable to whatever configuration having two or more recording destinations. For example, in a digital television apparatus or a hybrid recorder having at least two recording units (for example, BD recorder unit and HDD), a recording unit may set as a recording destination, and another recording unit may be set as a recording destination selectable by the automatic recording destination selection. Further, connection between apparatuses may be in any mode other than HDMI so far as recording can be controlled by the digital broadcast receiver having a recording function according to the present invention. In terms of the recording control, the present invention can be achieved so far as a recording start and end of a predetermined channel can be performed, although the recording control may include controls of detail settings including the recording image quality.

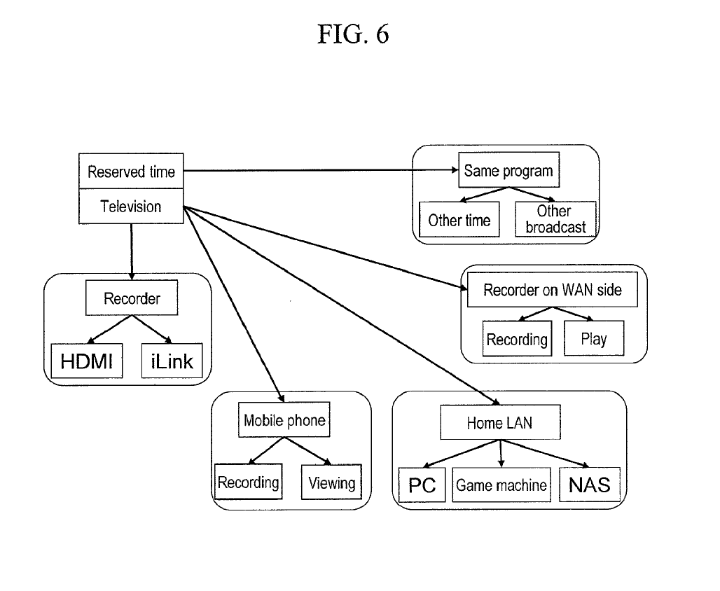

FIG. 6 is a diagram for explaining various configurations to which the present invention can be applied. The digital broadcast receiver having a recording function according to the present invention is generally a digital television apparatus having a recording function, which, however, may be another apparatus such as a hybrid recorder and a PC having a recording function. An apparatus connected to the digital broadcast receiver having a recording function as a selectable recording destination may include various recorders connected via HDMI, iLINK or the like, a mobile phone, a PC or gaming machine connected via home LAN, and recording devices connected via NAS or WAN, or the like. Those apparatuses may perform reserved recording in addition to or in place of a recording function of a digital television apparatus. Further, such apparatuses may perform a reserved viewing in addition to or in place of a recording function of the digital television apparatus. Further, a program being broadcast in another channel in a same time range with a program for reserved recording, and a program for reserved booking and being broadcast at a different time may be automatically recorded by any of such apparatuses.

The digital broadcast receiver having a recording function according to the present invention is also capable of performing the reserved recording of a pay program, for example, via the control function thereof. Specifically, the control unit 21 determines whether or not a program for reserved recording is a pay program or a free program. If the program is determined to be a pay program, the control unit 21 further determines whether or not the user has a subscription agreement. If the program is determined to be a free or contracted program, reserved recording is performed by the BD recorder unit 27. If the program is a non-contracted pay program, reserved recording by the BD recorder unit 27 is held until a contract is made, and reserved recording is performed by an externally connected device.

### INDUSTRIAL APPLICABILITY

The present invention may be utilized as a digital broadcast receiver having a recording function.

1.-8. (canceled)

9. A digital broadcast receiver having a recording function, characterized in that
the digital broadcast receiver comprises:
a connection means for connecting to another apparatus having a recording function,
an interface means for receiving, in reserved recording, a setting of performing reserved recording preferentially by the recording function of the receiver, and
a control means for performing such a control that,
in a case where the setting of performing reserved recording preferentially by the recording function of the receiver has been made in the interface means, the control means determines, in reserved recording, whether or not the recording function of the receiver is available for the recording,
when the recording function of the receiver is available for the recording, the control means performs the recording by the recording function of the receiver,
when the recording function of the receiver is not available for the recording, the control means causes the other apparatus connected to the connection means to perform the reserved recording, and
when determining that the recording function of the receiver is not available for the recording due to shortage of storage capacity, in the reserved recording, the control means performs such a control as to cause the other apparatus connected to the connection means to perform the reserved recording, and perform the reserved recording by the recording function of the receiver.

10. The digital broadcast receiver according to claim 9, characterized in that
the interface means receives a setting of always performing reserved recording by both of the recording function of the receiver and a recording function of the other apparatus, and
when the setting of always performing reserved recording by both of the recording function of the receiver and the recording function of the other apparatus has been made in the interface means, the control means performs, in the reserved recording, such a control as to simultaneously perform the recording by the recording function of the receiver, and cause the other apparatus connected to the connection means to perform the recording.

11. The digital broadcast receiver according to claim 9 or 10, characterized in that
when determining that the recording function of the receiver is not available for the recording, and when the control means performs such a control as to cause the other apparatus connected to the connection means to perform the recording, the control means outputs a message notifying to that effect.

12. The digital broadcast receiver according to claim 11, characterized in that
when determining that the recording function of the receiver is not available for the recording, and when the control means performs such a control as to cause the other apparatus connected to the connection means to perform the recording and the recording by the other apparatus has failed, the control means outputs a message notifying to that effect.

13. A method for performing reserved recording in a digital broadcast receiver having a recording function and connected to another apparatus having a recording function, characterized in that
the method comprises:
a step of receiving a setting of performing reserved recording only by the recording function of the receiver or a setting of performing reserved recording preferentially by the recording function of the receiver;
a step of determining, a predetermined time before a start time of reserved recording, whether or not the setting of performing the reserved recording only by the recording function of the receiver has been made;
a step of performing the reserved recording only by the recording function of the receiver when determining that the setting of performing the reserved recording only by the recording function of the receiver has been made;
a step of determining whether or not the recording function of the receiver is available for the reserved recording when determining that the setting of performing the reserved recording only by the recording function of the receiver has not been made;
a step of performing the reserved recording only by the recording function of the receiver when determining that the recording function of the receiver is available for the reserved recording;
a step of performing the reserved recording only by the recording function of the other apparatus when determining that the recording function of the receiver is not available for the reserved recording; and
a step of causing the recording function of the other apparatus to perform the reserved recording and also performing the reserved recording by the recording function of the receiver when determining that the recording function of the receiver is not available for the reserved recording.

14. A computer-readable recording medium storing the program for causing a computer to execute the method according to claim 13.
